(19) United States
(12) Patent Application Publication
(10) Pub. No.: US 2009/0120329 A1
(43) Pub. Date: May 14, 2009

(54) Hardening and Setting Accelerator Additive, Use of the Latter and Method for Producing Said Additive

(75) Inventors: Christophe Kurz, Buchs (CH); Heinz Schurch, Gontenschwil (CH); Benedikt Lindlar, Konstanz (DE); Franz Wombacher, Oberlunkhofen (CH); Urs Mader, Frauenfeld (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 11/886,328

(22) PCT Filed: Mar. 16, 2006
(86) PCT No.: PCT/EP2006/002437

§ 371 Date: Dec. 4, 2008

(30) Foreign Application Priority Data
Mar. 16, 2005 (EP) 05102071.7
Mar. 21, 2005 (CH) 00477/05

(51) Int. Cl. C04B 28/00; C04B 14/00

(52) U.S. Cl. 106/639; 106/310

(57) ABSTRACT

The invention relates to a hardening and setting accelerator additive consisting of two components. The first component contains agents for developing the rigidity of the binding agent and the second component is an activating component and/or a texturing component.

### TECHNICAL FIELD

The invention proceeds from a setting and curing accelerator for hydraulic binders according to the preamble of the first claim. The invention likewise proceeds from a use and a process for producing a setting and curing accelerator for hydraulic binders according to the preamble of the respective independent claims.

### PRIOR ART

Many substances which accelerate the setting and curing of concrete are known. Customarily used materials are, for example, strongly alkaline substances such as alkali metal hydroxides, alkali metal carbonates, alkali metal silicates, alkali metal aluminates and alkaline earth metal chlorides. However, the strongly alkaline substances cause undesirable problems for the processor, for example chemical burns, and they reduce the final strength and the durability of the concrete.

EP 0 076 927 B1 discloses alkali-free setting accelerators for hydraulic binders which are said to avoid these disadvantages. To accelerate setting and curing of a hydraulic binder such as cement, lime, hydraulic lime and gypsum plaster and also mortar and concrete produced therefrom, from 0.5 to 10% by weight, based on the weight of the binder mentioned, of an alkali-free setting and curing accelerator are added to the mixture containing this binder, with this accelerator containing aluminum hydroxide. Such mortars and concretes are particularly suitable as spray mortar and spray concrete because of the accelerated setting and curing.

EP 0 946 451 B1 discloses setting and curing accelerators in dissolved form for hydraulic binders, which can more easily be mixed into the concrete when spraying the concrete. Such a setting and curing accelerator comprises, inter alia, aluminum hydroxide, aluminum salts and organic carboxylic acids. Such known accelerators contain a relatively large amount of aluminum salts and their production requires amorphous aluminum hydroxide, which is very expensive. To make it possible to produce such accelerators, the water for the reaction has to be heated to about 60-70° C. Further disadvantages of such setting and curing accelerators are a relatively low early strength in the first hours and days and the unsatisfactory stability of the solution.

### SUMMARY OF THE INVENTION

It is an object of the invention to achieve, for a setting and curing accelerator for hydraulic binders of the abovementioned type, a very high strength combined with a very long storage life of the accelerator. According to the invention, this is achieved by the features of the first claim.

Advantages of the invention are, inter alia, that the use of two separately introduced components makes the accelerator as first component significantly more reactive. Hitherto, the accelerator was in wet spraying processes mixed into the concrete as one component at the nozzle during spraying. Such accelerators comprise a plurality of active constituents which also act individually. If these constituents were to be placed individually in the fresh concrete, this would lead to stiffening.

According to the invention, it has now been found that a second component which does not lead to stiffening of the concrete but makes the accelerator significantly more reactive can be added to the fresh concrete. It is possible to use any conventional accelerator here. This second component can be mixed into the fresh concrete during production of the latter without the processability being significantly impaired. The concrete prepared using a second component according to the invention is significantly more reactive toward the accelerator, so that improved early strength and better further strength development up to at least 24 hours are achieved. The second component can also be introduced in parallel to the actual accelerator at the spray nozzle. However, the addition of the second component can be effected at any point, e.g. during transport, on site in a concrete mixer, at the pump, etc. However, addition to the fresh concrete is particularly advantageous since this can be carried out in the concrete plant and no further components have to be processed on site.

Since, in particular, the strength development over a period of a few hours often presents a problem when using the present-day alkali-free accelerators, this can be improved by addition of the second component according to the invention.

Although WO 9211892 A1 describes the method of a two-component system for spray concrete accelerators in principle, this patent relates essentially to the combination with the plasticizer and its plasticizing action or its elimination.

Further advantageous embodiments of the invention may be derived from the description and the dependent claims.

### BRIEF DESCRIPTION OF THE DRAWING

Examples of the invention are described below with the aid of the drawings.

In the drawings:

FIG. 1 shows the early strength values for examples 1 to 3;

FIG. 2 shows the 4h compressive strength values for examples 1 to 3;

FIG. 3 shows the early strength values for examples 4 to 8;

FIG. 4 shows the 4h compressive strength values for examples 4 to 8;

FIG. 5 shows the early strength values for examples 9 to 11;

FIG. 6 shows the 4h compressive strength values for examples 9 to 11;

FIG. 7 shows the early strength values for examples 12 to 16;

FIG. 8 shows the 4h and 5h compressive strength values for examples 12 to 16.

### WAYS OF CARRYING OUT THE INVENTION

Accelerator Component

Setting and curing accelerators for hydraulic binders are generally known, and it is in principle possible to use any setting and curing accelerators for the purposes of the present invention. Aluminum-containing accelerators which lead to ettringite formation in the concrete are particularly advantageous.

Advantageous setting and curing accelerators which can be used according to the present invention comprise (in % by weight):

0-30% of aluminum hydroxide

0-50% of aluminum sulfate

0-40% of formic acid, 85% (or an equivalent molar amount of another carboxylic acid)

0-15% of other metal oxides/hydroxides

0-20% of inorganic acids

0-25% of alkali metal hydroxide

0-25% of alkali metal carbonate

0-10% of other specific additives

Advantageous alkali-free setting and curing accelerators which can be used according to the present invention comprise (in % by weight):

0-30% of aluminum hydroxide

0-50% of aluminum sulfate

0-40% of formic acid, 85% (or an equivalent molar amount of another carboxylic acid)

0-15% of other metal oxides/hydroxides

0-20% of inorganic acids

0-10% of other specific additives

In the case of these accelerators, it is particularly advantageous for the molar ratio of aluminum to the organic acid to be greater than 0.3 and the molar ratio of aluminum to sulfate to be greater than 0.50.

Accelerators which have an aluminum content of up to 10% are particularly advantageous.

A particularly advantageous water-based setting and curing accelerator for hydraulic binders has a molar ratio of aluminum to the organic acid of less than or equal to 0.65 and is designated as L53 AFS in the examples below.

For the present purposes, a water-based accelerator is an accelerator which can occur as a solution, as a solution containing some finely dispersed particles or as a dispersion.

Such a water-based setting and curing accelerator advantageously comprises (in % by weight):
from 14.4 to 24.9% of sulfate,
from 4 to 9.7% of aluminum (or from 7.6 to 18.3% of Al₂O₃)
12-30% of organic acid,
0-10% of alkaline earth
0-10% of alkanolamine,
0-5.0% of plasticizer,
0-20% of stabilizer;
plus water, with the molar ratio of aluminum to the organic acid being less than or equal to 0.65.

The aluminum content reported as Al₂O₃ is preferably less than 14%, particularly preferably less than 13% and in particular less than 12%, of Al₂O₃.

The abovementioned substances are advantageously present as ions in solution, but can also occur in complexed form or undissolved in the accelerator. This is, in particular, the case when the accelerator is present as a solution containing some finely dispersed particles or as a dispersion.

A water-based setting and curing accelerator for hydraulic binders can be produced, for example, from Al₂(SO₄)₃ aluminum sulfate, Al(OH)₃ aluminum hydroxide and organic acid in aqueous solution, with the molar ratio of aluminum to the organic acid being less than or equal to 0.65.

To produce a preferred water-based setting and curing accelerator, it is advantageous to use (in % by weight):
30-50% of Al₂(SO₄)₃ aluminum sulfate,
5-20% of Al(OH)₃ aluminum hydroxide,
12-30% of organic acid,
0-10% of alkaline earth metal hydroxide
0-10% of alkaline earth metal oxide,
0-10% of alkanolamine,
0-5.0% of plasticizer,
0-20% of stabilizer,
balance water, with the molar ratio of aluminum to the organic acid being less than or equal to 0.65.

Preference is given to using an aluminum sulfate having an Al₂O₃ content of about 17%, but it is also possible to use other contents, in which case the amounts to be added have to be adapted accordingly. The aluminum sulfate can also be produced by reaction of aluminum hydroxide with sulfuric acid in the production of the accelerator, resulting in formation of appropriate sulfate ions in the aqueous solution. In general, aluminum sulfate can be produced by reaction of a basic aluminum compound with sulfuric acid.

As aluminum hydroxide, it is advantageous to use amorphous aluminum hydroxide. The aluminum hydroxide can also be used in the form of aluminum hydroxide carbonate, aluminum hydroxysulfate or the like.

As organic acid, preference is given to using a carboxylic acid, particularly preferably a formic acid, but it is also possible to use other organic acids such as acetic acid which have an equivalent action. In general, however, all monobasic or polybasic carboxylic acids can be used.

Since sulfate is used in the accelerator, magnesium hydroxide Mg(OH)₂ is preferably used as alkaline earth metal hydroxide. The same applies to the alkaline earth metal oxide, so that magnesium oxide MgO is preferably used in that case.

As alkanolamine, it is advantageous to use diethanolamine DEA.

As plasticizer, it is advantageous to use polycarboxylates and particularly advantageously Sika ViscoCrete®.

As stabilizer, it is advantageous to use silica sol.

To produce particularly advantageous setting and curing accelerators, use is essentially made of (in % by weight):
30-50% of Al₂(SO₄)3 aluminum sulfate, preferably 35-45%, in particular 35-38%, and/or
5-20% of Al(OH)₃ aluminum hydroxide, in particular 7-15%, and/or
15-23% of organic acid and/or
1-10% of alkaline earth metal hydroxide, in particular 2-6%, and/or
1-5% of alkaline earth metal oxide and/or
1-3% of alkanolamine and/or
0.1-3.0% of plasticizer, in particular from 0.1 to 1.0%, and/or
0-10% of stabilizer
balance water, with the molar ratio of aluminum to the organic acid being less than or equal to 0.65, preferably less than 0.60, particularly preferably less than 0.55 and in particular less than 0.50.

The molar ratio of aluminum to the organic acid is preferably in the range from 0.38 to 0.65, particularly preferably in the range from 0.38 to 0.60, in particular from 0.50 to 0.60. Below a value of 0.38, the pH becomes relatively low and a very large proportion of acid has to be used; in addition, stability is sometimes no longer ensured.

Compared to conventional setting accelerators, the amount of aluminum sulfate used in production of the accelerator and also, in particular, that of aluminum hydroxide is reduced by up to 10% and 38%, respectively. Preference is given to using up to 10% of magnesium hydroxide and/or a corresponding amount of magnesium oxide in the production of the accelerator. The amount of Mg calculated as such and based on the total amount of accelerator is from 0 to 4.2%, preferably from 0.8 to 2.9%, particularly preferably from 1.3 to 2.1%.

The ratio of aluminum to the organic acid is set to a value of less than 0.65, preferably less than 0.60, by the increased (compared to known accelerators) organic acid content and the pH is set to 3-4 by means of up to 5% of alkanolamine.

The reduction of up to 25% in the amount of the aluminum used in production of the accelerator improves the sulfate resistance. This is an advantage over conventional accelerators which drastically reduce the sulfate resistance. The reduction in the sulfate resistance by introduction of aluminum is caused, in particular, by the aluminate phases having a particular affinity for sulfate. The additional aluminum increases the proportion of aluminate phases in the concrete, which then cause a not insignificant crystallization pressure due to ettringite formation when external sulfate acts on the cured concrete and thus lead to damage. The aluminum content reported as Al₂O₃ is therefore preferably less than 14%, particularly preferably less than 13% and in particular less than 12%, of Al₂O₃.

If magnesium hydroxide and/or oxide are used in the production of the accelerator, the temperature of the mixture is increased by the vigorous reaction of the magnesium hydroxide and/or oxide with the organic acid to such an extent that the water for these mixes does not have to be heated. The further components are then added to this heated mixture. However, the components can also be added in any other order. This simplifies the process and less energy is required. An additional advantage of the use of magnesium is the significantly higher storage stability of the accelerators brought about by the magnesium ions. A good storage stability is achieved when a proportion of magnesium hydroxide of as little as 1% by weight is used in production of the binder. At higher contents, the storage stability is at least four months. The use of magnesium hydroxide and/or oxide also makes it possible to produce the accelerator significantly more cheaply since expensive aluminum hydroxide can be replaced. In addition, the reduced amount of aluminum has a positive influence on the stability of the accelerators. The reduced amount of aluminum also increases the sulfate resistance.

The development of the compressive strength of the spray concrete in the first hours and days is also influenced very positively and is better than in the case of conventionally used accelerators.

Second Component

The second component serves to improve the action of the accelerator significantly without the second component itself leading to earlier setting of the binder.

The second accelerator component can for this purpose comprise one of the two following variants or a combination of the two:

Variant a)

A chemically active second component which does not itself accelerate the setting of the binder but in the ideal case even retards it activates the binder for the actual accelerator, so that after the introduction of this accelerator a significantly improved early strength and further strength development during the first hours or days is achieved.

This additional component is a complexing agent, preferably a complexing agent for calcium, preferably a hydroxydicarboxylic acid, particularly preferably a dicarboxylic acid, in particular oxalic acid, or a mixture of the abovementioned substances.

The abovementioned substances, but in particular oxalic acid, is/are added in an amount of 0.1-2.0%, preferably 0.3-1.5%, particularly preferably 0.5-1.0%, in particular 0.7-0.9%, based on the hydraulic binder.

In addition, 0-20% of fumed silica, e.g. SikaFume-HR/-TU can be added to improve meterability and improve concrete properties.

Variant b)

A structurally active second component which has itself no significant effect on the setting of the binder but, particularly in the early phase and up to the first days, strengthens the mineral phases formed during this time.

Such an additional component is an agent having a thixotropic effect, preferably an anisotropically charged aluminosilicate, preferably a magnesium aluminosilicate (clay minerals, attapulgites), preferably a nonswelling magnesium aluminosilicate, particularly preferably an attapulgite, in particular Acti-Gel® 208 or a mixture of the abovementioned substances. Acti-Gel® 208 is a product of Active Minerals and is a specially prepared attapulgite. The abovementioned substances, but in particular attapulgite or Acti-Gel® 208, are added in an amount of 0.01-5.0%, preferably 0.1-2.0%, particularly preferably 0.15-1.0%, based on the hydraulic binder.

It is naturally also possible to add a mixture of the second components mentioned under a) and b) . Here, the second components can be used in the abovementioned ranges in the mixture since the second components of variant a) and b) do not compete but supplement one another. Particular preference is in this case given to a mixture of 0.25-2.0% of oxalic acid with 0.05-1.5% of Acti-Gel® 208, in particular 0.8% of oxalic acid with 0.25% of Acti-Gel® 208.

The addition of the second accelerator component can be carried out in various ways. The second component is a liquid (solution or dispersion) or a powder, or a mixture thereof.

The second component is mixed into the concrete either separately or as a combination with the plasticizer or other additives in the concrete plant or can be added only at the spray nozzle as additional component. Liquid secondary components are particularly suitable for this purpose. It is naturally also possible to add the second component at another point prior to actual processing or to add only part of the second component at each of various points.

### EXAMPLES

In the present experiments, portland cement was used as binder and a typical alkali-free setting accelerator for spray concrete, viz. Sigunit L53 AFS, was utilized as first component. The Sigunit L53 AFS used here had a composition of (in % by weight):
37.0% of Al₂(SO₄)₃ aluminum sulfate,
10.0% of Al(OH)₃ aluminum hydroxide,
18.3% of formic acid,
4.5% of magnesium hydroxide,
3.0% of alkanolamine,
balance water, with the molar ratio of aluminum to the organic acid being 0.65.

The second components as shown in table 1 were all added to the dry mix and were thus present from the beginning in the fresh mortar. In the case of the chemically activating second component, this can, depending on the form in which it is present (free-flowing, hygroscopic), be admixed with a powder flow aid, preferably finely divided silica, e.g. up to 3% of Sipernat 22 S (Degussa) or up to 3% of Cab-O-Sil TS 720, with many others also being possible. As an alternative, the second chemically activating component can be combined with fumed silica, using a special fumed silica for spray concrete. The use of fumed silica can reduce the amount of portland cement used.

TABLE 1

| | | Oxalic acid | Actigel | Fumed silica |
|---|---|---|---|---|
| Series 1 | Example 1 | 0.00% | | |
| | Example 2 | 0.40% | | |
| | Example 3 | 0.80% | | |
| Series 2 | Example 4 | 0.00% | | 0.00% |
| | Example 5 | 0.40% | | 5.00% |
| | Example 6 | 0.40% | | 10.00% |
| | Example 7 | 0.80% | | 5.00% |
| | Example 8 | 0.80% | | 10.00% |
| Series 3 | Example 9 | | | 0.00% |
| | Example 10 | | | 5.00% |
| | Example 11 | | | 10.00% |
| Series 4 | Example 12 | | 0.00% | |
| | Example 13 | | 0.25% | |
| | Example 14 | | 0.50% | |
| | Example 15 | | 1.00% | |
| | Example 16 | 0.80% | 0.24% | |

Spray Tests

All amounts added are based in each case on the amount of cement, i.e. the amount of hydraulic binder used. The tests were carried out in a spraying laboratory using a mortar having a particle size of 0-4 mm and a water/cement ratio w/c=0.48. All mixtures were plasticized using 1.1% of ViscoCrete® SC 305 and retarded. The liquid accelerator component used here, Sigunit L53 AFS, was as customary introduced at the spray nozzle in an amount of 6% (based on the binder).

The early strength was in each case measured by means of a Proctor penetrometer during the first hour after spraying. The further strength development was determined after 4-6 hours by means of a Hilti indenter and after 24 hours the compressive strength was determined on 5×5 cm drill cores.

Results

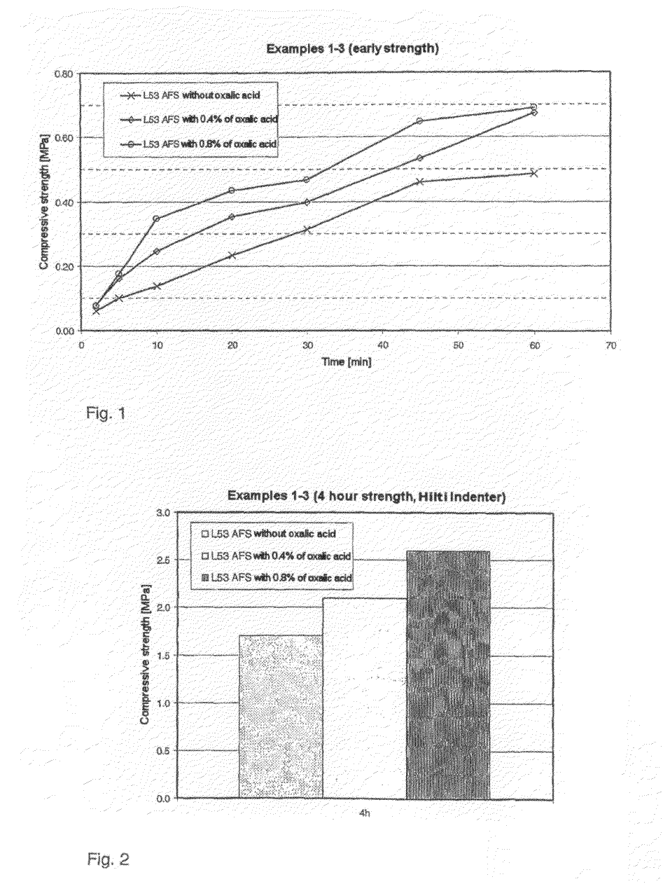

The results are shown in graph form in FIGS. 1 to 10. To ensure very good comparability, the results are always presented as a comparison within the respective spraying series and together with the respective reference measurement. Even though the spray tests in the laboratory are relatively readily controllable, there are always fluctuations caused by parameters which can be controlled only with difficulty, if at all.

Series 1, 2, (4) Using Oxalic Acid

The addition of oxalic acid improves the accelerating action of the conventional alkali-free accelerator without itself producing a significant change in the processability of the concrete and in particular without shortening the open time of the concrete. The results of the experiments using a second component corresponding to examples 1 to 3, which can be seen in FIGS. 1 and 2, demonstrate the greatly improved early strength and the 4 hour compressive strength, with these values increasing continuously with increasing content of oxalic acid.

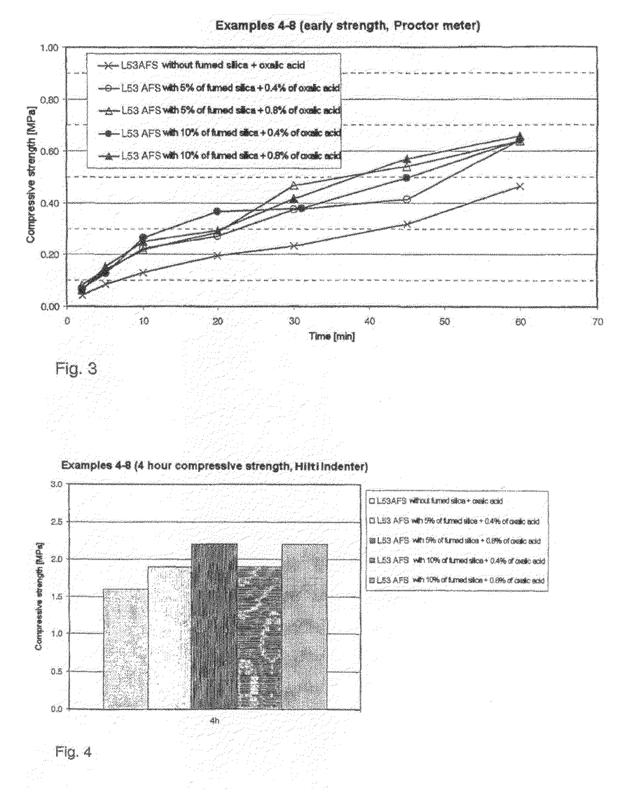

The results of the experiments using a second component corresponding to examples 4 to 8, which can be seen in FIGS. 3 and 4, demonstrate the greatly improved early strength and the 4 hour compressive strength, with the addition of fumed silica having no effect on the action of the accelerator.

Series 2, 3 Using Fumed Silica

Combination with fumed silica is very readily possible and useful and represents a good addition variant for oxalic acid.

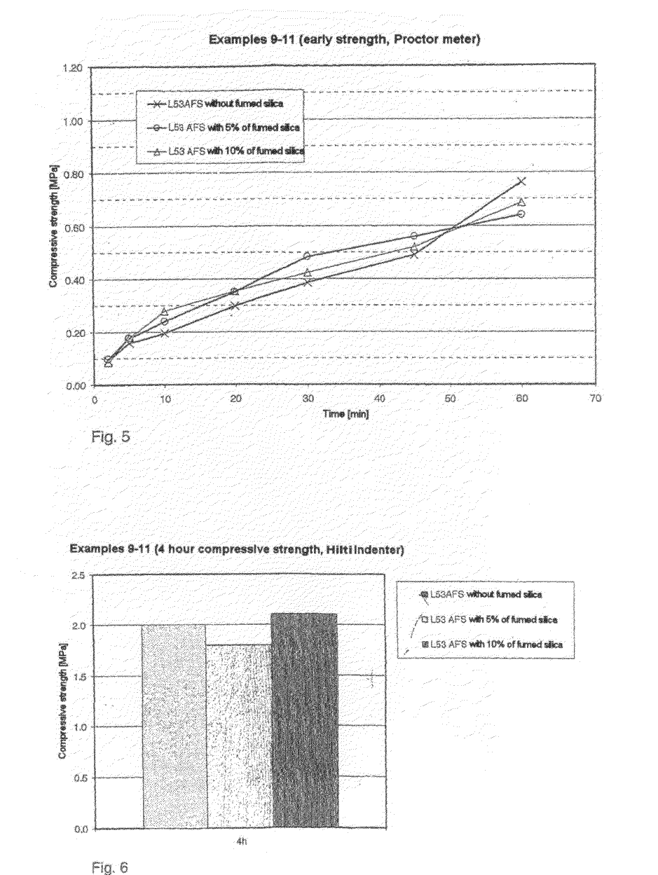

The results of the experiments using a second component corresponding to examples 4 to 8, which can be seen in FIGS. 3 and 4, demonstrate the greatly improved early strength and the 4 hour compressive strength, with the addition of fumed silica having no influence on the action of the accelerator. This can also be seen from examples 9 to 11, FIGS. 5 and 6, where pure fumed silica is used and no improvement in the accelerating action is observed. In this series, the amount of portland cement was in each case reduced by the amount of fumed silica.

Series 4 Using Attapulgite

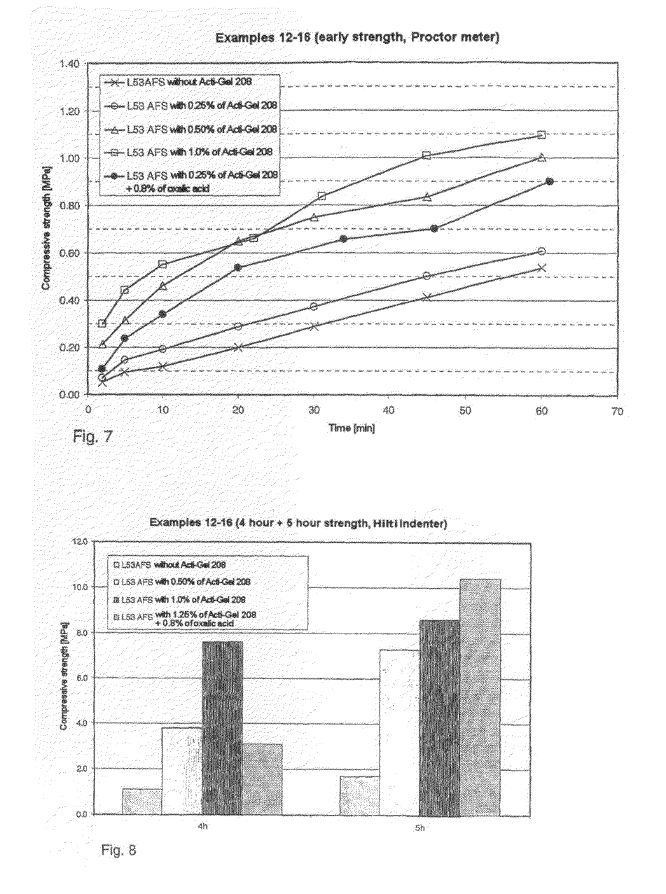

A significant increase in performance of the accelerator is observed as a result of the addition of attapulgite, Acti-Gel® 208, in the fresh concrete. The results of the experiments using a second component corresponding to examples 12 to 15, which can be seen in FIGS. 7 and 8, demonstrate the greatly improved early strength and the 4 hour compressive strength, with these values increasing continuously with increasing content of Acti-Gel® 208.

The combination with oxalic acid as per example 16 shows that the performance can be improved further (0.25% of Acti-Gel® 208, 0.80% of oxalic acid); the effects of the two alternative components therefore supplement one another.

Of course, the invention is not restricted to the example presented and described. Apart from cement, it is also possible to use mixed cements, lime, hydraulic lime and gypsum plaster and mortar and concrete produced therefrom as hydraulic binder.

1. A setting and curing accelerator for hydraulic binder comprising two components, wherein the first component contains agents for stiffening the binder and the second component is an activating component and/or a structuring component.

2. The setting and curing accelerator as claimed in claim 1, wherein the second activating component is a complexing agent.

3. The setting and curing accelerator as claimed in claim 2, wherein the second activating component is present in a proportion of 0.1-2.0% based on the hydraulic binder.

4. The setting and curing accelerator as claimed in claim 1, wherein the second structuring component is an agent having a thixotropic effect.

5. The setting and curing accelerator as claimed in claim 4, wherein the second structuring component is present in a proportion of 0.01-5.0% based on the hydraulic binder.

6. The setting and curing accelerator as claimed in claim 1, wherein the second component is a complexing agent or oxalic acid and/or an agent having a thixotropic effect.

7. The setting and curing accelerator as claimed in claim 1, wherein the first component has an aluminum content of up to 10%.

8. The setting and curing accelerator as claimed in claim 1, wherein the first component comprises sulfate, aluminum and organic acid.

9. The setting and curing accelerator as claimed in claim 8, wherein the first component has a molar ratio of aluminum to the organic acid of from 0.38 to 13.3.

10. The setting and curing accelerator as claimed in claim 8, wherein the first component comprises (in % by weight): from 14.4 to 24.9% of sulfate, from 4 to 9.7% of aluminum and 12-30% of organic acid.

11. A spray concrete or spray mortar which is applied by means of a spray nozzle and comprises the setting and curing accelerator as claimed in claim 1, wherein the first component is introduced into the spray concrete or spray mortar in the region of the spray nozzle and the second component is introduced at any point in the production, transport and/or further processing of the spray concrete or spray mortar.

12. The spray concrete or spray mortar as claimed in claim 11, wherein the second component is added before the first component.

13. The spray concrete or spray mortar as claimed in claim 11, wherein the second component is introduced into the fresh concrete or fresh mortar.

14. A process for producing a setting and curing accelerator as claimed in claim 1, wherein the first component and the second component are produced separately so that they can be added to the hydraulic binder separately from one another at different points.
